(19) United States
(12) Patent Application Publication
(10) Pub. No.: US 2026/0365939 A1
(43) Pub. Date: Nov. 19, 2026

(54) LIGHT DUTY LIQUID DETERGENTS

(71) Applicant: Indorama Ventures Oxides LLC, The Woodlands, TX (US)

(72) Inventors: Thu Thi Le LANDRY, The Woodlands, TX (US); Ivan Douglas WILLIAMS, The Woodlands, TX (US); Jamie Nicole HENDRIX, The Woodlands, TX (US); Makayla PFARRER, The Woodlands, TX (US)

(21) Appl. No.: 19/725,243

(22) Filed: Jun. 30, 2026

Related U.S. Application Data
(63) Continuation of application No. PCT/US2025/011071, filed on Jan. 10, 2025.
(60) Provisional application No. 63/625,563, filed on Jan. 26, 2024.
(60) Provisional application No. 63/740,102, filed on Dec. 30, 2024.

(51) Int. Cl. C11D 1/22; C11D 1/29; C11D 3/04; C11D 3/30; C11D 17/08

(52) U.S. Cl. CPC C11D 1/22; C11D 1/29; C11D 3/044; C11D 3/30; C11D 17/08; C11D 2111/14

(57) ABSTRACT

A light duty liquid detergent formulation having from 0.5% to 30% by weight of alkylbenzene sulfonates based on a total weight of the detergent formulation and at least 65% of the alkylbenzene sulfonates having a C₁₂ alkyl group. The detergent formulation also includes a neutralizing agent and water.

### CROSS-REFERENCE TO RELATED APPLICATIONS

This application is a bypass continuation of PCT Application No. PCT/US2025/011071, filed Jan. 10, 2025, which claims benefit of U.S. Provisional Patent Application Ser. No. 63/625,563, filed Jan. 26, 2024, and U.S. Provisional Patent Application Ser. No. 63/740,102, filed Dec. 30, 2024, which applications are incorporated herein by reference in their entirety.

### TECHNICAL FIELD

Embodiments described herein are generally related to light duty liquid detergents containing alkylbenzene sulfonates. In particular, embodiments of the present disclosure relate to improved light duty liquid detergents containing linear alkylbenzene sulfonates with at least 65% of the linear alkylbenzene sulfonates having a C12 alkyl group.

### BACKGROUND

Light duty liquid (“LDL”) detergents provide effective cleaning of dishes and tableware when manually washed by a consumer. These LDL detergents may come in a variety of forms and dilutions and typically provided as free flowing viscous liquids. The LDL detergents may have viscosities ranging from water thin to more viscous but pourable mixtures.

These LDL detergents are typically readily dilutable in water and are particularly effective in cutting grease and other soils that may be present on the dishes or tableware. Ineffective cleaning may lead to dissatisfaction with the use of such commercial product by the consumer.

Additionally, the LDL detergents should exhibit good foam height. Consumers often associate good foam height with good cleaning performance. While there is little relationship between good cleaning performance and the visible foam, consumer perceptions are very hard to overcome. Thus, good foam height is another desirable property of the light duty dishwashing detergent.

LDL detergents possessing these properties are known in the industry and readily available. Nevertheless, there remains a continuing need in the industry for improvements to light duty dishwashing detergents.

### SUMMARY

In some embodiments, a light duty liquid detergent formulation includes from 0.5% to 30% by weight of alkylbenzene sulfonates based on a total weight of the detergent formulation and at least 65% of the alkylbenzene sulfonates having a C12 alkyl group. The detergent formulation also includes a neutralizing agent and water.

In some embodiments, a liquid dishwashing detergent includes a linear alkylbenzene sulfonate having an average alkyl chain length of from 11.7 carbons to 11.95 carbons. The linear alkylbenzene sulfonate present in an amount from 0.5% to 30% by weight based on a total weight of the dishwashing detergent. The dishwashing detergent also includes a neutralizing agent and water.

### BRIEF DESCRIPTION OF THE DRAWINGS

FIG. 1 is an example graph illustrating a foam profile of LDL formulations prepared with F1 recipe (LAS+FB) at 0.1 wt % in 150 ppm hard water (Ca/Mg=2/1) at ambient temperature.

FIG. 2 is an example graph illustrating a foam profile of LDL formulations prepared with F2 recipe (LAS+FB+SLES 3) at 0.1 wt % in 150 ppm hard water (Ca/Mg=2/1) at ambient temperature.

FIG. 3 is an example graph illustrating cleaning efficacy based on number of plates cleaned.

FIG. 4 is another example graph illustrating cleaning efficacy based on number of plates cleaned.

### DETAILED DESCRIPTION

Embodiments of the present disclosure provide a light duty liquid (LDL) detergent formulation containing linear alkybenzene sulfonate having 65% or higher C12 content in the alkyl distribution. Embodiments of the formulation surprisingly showed improved cleaning efficiency in hand dishwashing at very low concentration, as low as 100 ppm.

In some embodiments, the linear alkylbenzene may be neutralized with different neutralizing agents such as sodium hydroxide, monoisopropanolamine (MIPA), diisopropranolamine (DIPA), triisopropanolamine (TIPA).

In one embodiment, the detergent formulation includes an anionic surfactant such as alkylbenzene sulfonates, for example, linear or branched alkylbenzene sulfonates. In some embodiments, the alkyl group of the alkylbenzene sulfonates may be a C₅-C₂₀ alkyl group. In some examples, the alkylbenzene sulfonates include a mixture of alkylbenzene sulfonates with different C₅-C₂₀ alkyl groups. For example, 65% or higher of the alkylbenzene sulfonates include a C₁₂ alkyl group. In other words, the alkylbenzene sulfonates may have 65% or higher C₁₂ content in the alkyl distribution. The remaining portions of the alkylbenzene sulfonates may have C₅-C₂₀ alkyl groups other than C₁₂ alkyl group. In some examples, the alkylbenzene sulfonates have from 60% to 98% C₁₂ content, from 65% to 95% C₁₂ content, from 70% to 90% C₁₂ content, or from 70% to 85% C₁₂ content in the alkyl distribution. In some examples, the alkylbenzene sulfonate is a linear alkylbenzene sulfonate (“LAS”) having from 70% to 80% C₁₂ content or from 72% to 78% C₁₂ content in the alkyl distribution. In one example, the 75% C₁₂ the alkylbenzene sulfonate may be obtained by mixing equal amount of a first alkylbenzene sulfonate containing 50% C₁₂ alkylbenzene sulfonate and a second alkylbenzene sulfonate containing 100% C₁₂ alkylbenzene sulfonate. It is noted that both of the first alkylbenzene sulfonate containing 50% C₁₂ alkylbenzene sulfonate and the second alkylbenzene sulfonate are commercially available.

In some examples, the detergent formulation includes linear alkylbenzene sulfonates having an average alkyl chain length of from 11.7 carbons to 11.95 carbons, from 11.75 carbons to 11.9 carbons, or from 11.75 carbons to 11.85 carbons. In one example, the linear alkylbenzene sulfonates have an average alkyl chain length of about 11.8, which represents about 75% of the alkylbenzene sulfonates include a C₁₂ alkyl group.

The alkylbenzene sulfonates may be present in an amount from 0.5% to 30% weight percent by total weight of the detergent formulation. For example, the alkylbenzene sulfonates may be present in an amount from 3% to 20% by weight, from 8% to 20% by weight, or from 10% to 18% by weight (such as 11%, 12%, 13%, 14%, 15%, 16%, 17%) of the total weight of the detergent formulation. In some embodiments, the alkylbenzene sulfonates is used in the acid form, for example, linear alkylbenzene sulfonic acid.

In some embodiments, the detergent formulation includes a neutralizing agent to neutralize the alkylbenzene sulfonic acid. Any suitable neutralizing agent may be used to neutralize the acid. Exemplary neutralizing agents include alkalis such as sodium hydroxide or potassium hydroxide. Other suitable neutralizing agents include monoisopropanolamine (MIPA), diisopropranolamine (DIPA), and triisopropanolamine (TIPA). In one example, the neutralizing agent is sodium hydroxide. In some embodiments, the neutralizing agent may be added in an amount sufficient to achieve a suitable pH level. Suitable pH levels may be from 7 to 10, such as from 5.5 to 9. The neutralizing agent may be present in an amount from 0.5% to 10% by weight or from 0.5% to 7% by weight of the total weight of the detergent formulation.

In some embodiments, the detergent formulation may optionally include other anionic surfactants different from the alkylbenzene sulfonates. Other suitable anionic sulfonate surfactants include alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Anionic sulfate surfactants are also suitable for use in the detergent formulation. Exemplary anionic sulfate surfactants include linear and branched primary and secondary alkyl sulfates, alkyl ethoxy sulfates, fatty oleoyl glycerol sulfates, and alkyl phenol ethylene oxide ether sulfates. Suitable anionic carboxylate surfactants include alkyl ethoxy carboxylates, alkyl polyethoxy polycarboxylate surfactants and soaps (“alkyl carboxyls”). All anionic surfactants known for use as dishwashing agents are suitable. The anionic surfactant different from the alkylbenzene sulfonates may be present from 0.5% to 30% by weight, from 2.0% to 12% by weight, from 3% to 10% by weight, based on the total weight of the detergent formulation.

In some embodiments, the detergent formulation includes an optional ether sulfate. The ether sulfates are compounds of formula (I):

R¹—O-(AO)ₙ—SO₃—X+ (I)

In this formula (I), R¹ represents a linear or branched, substituted or unsubstituted alkyl group, for example a linear, unsubstituted alkyl group, typically a fatty alcohol group. Common groups R¹ are selected from decyl, undecyl, dodecyl, tridecyl, tetradecyl, pentadecyl, hexadecyl, heptadecyl, octadecyl, nonadecyl and eicosyl groups, and mixtures thereof, the representatives having an even number of C atoms being particularly customary. Typical groups R¹ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

X represents a monovalent cation or the n-th part of an n-valent cation, examples of these being the alkali metal ions, such as Na⁺ or K⁺. Other cations X⁺ may be selected from NH₄⁺, ½Zn²⁺, ½Mg²⁺, ½Ca²⁺, ½Mn²⁺, and mixtures thereof.

AO represents an ethylene oxide (EO) or propylene oxide (PO) group. The index n represents an integer from 1 to 30, preferably from 1 to 15 or from 2 to 10, such as n is 2, 3, 4, or 5.

In one example, the detergent formulation includes sodium lauryl ether sulfate (“SLES”) in an amount from 2.0% to 12% by weight or from 5% to 10% by weight, based on the total weight of the dishwashing detergent formulation.

In some embodiments, the detergent formulation optionally includes one or more foam stabilizers. The foam stabilizers may be present in an amount from 0.5% to 12% by weight or from 4% to 10% by weight, based on the total weight of the dishwashing detergent formulation. In some examples, the detergent formulation includes an amine oxide surfactant. Amine oxides useful in the detergent formulation include alkyl amine oxides having the formula (II)

R³(OR⁴)_{X}—(NO)—(R⁵)₂ (II)

wherein R³ is selected from an alkyl, hydroxyalkyl, acylamidopropyl and alkyl phenyl group, or mixtures thereof, containing from 8 to 26 carbon atoms, such as 8 to 16 carbon atoms; R⁴ is an alkylene or hydroxyalkylene group containing from 2 to 3 carbon atoms, such as 2 carbon atoms, or mixtures thereof; x is from 0 to 3; and each R⁵ is an alkyl or hydroxyalkyl group containing from 1 to 3 carbon atoms, such as from 1 to 2 carbon atoms, or a polyethylene oxide group containing from 1 to 3 ethylene oxide groups. The R⁵ groups can be attached to each other, such as through an oxygen or nitrogen atom, to form a ring structure.

Exemplary amine oxide surfactants include C₁₀-C₁₈ alkyl dimethyl amine oxides and C₈-C₁₂ alkoxy ethyl dihydroxyethyl amine oxides and alkyl amido propyl amine oxide. Suitable amine oxides include dimethyloctylamine oxide, diethyldecylamine oxide, bis-(2-hydroxyethyl) dodecylamine oxide, dimethyldodecylamine oxide, dodecylamidopropyl dimethylamine oxide and dimethyl-2-hydroxyoctadecylamine oxide. Preferred are C₁₀-C₁₈ alkyl dimethylamine oxide, and C₁₀-C₁₈ acylamido alkyl dimethylamine oxide.

In some examples, the detergent formulation includes a betaine as a foam stabilizer. Betaines useful in the detergent formulation include betaines having the formula (III)

R(R¹)₂N⁺R²COO⁻ (III)

where R is a C₆-C₁₈ hydrocarbyl group, such as C₁₀-C₁₆ alkyl group; each R¹ is typically C₁-C₃ alkyl group, such as methyl; and R² is a C₁-C₅ hydrocarbyl group, such as a C₁-C₅ alkylene group or a C₁-C₂ alkylene group.

Examples of suitable betaines include coconut acylamidopropyldimethyl betaine; hexadecyl dimethyl betaine; C₁₂-C₁₄ acylamidopropylbetaine; C₁₂-C₁₈ acylamidohexyldiethyl betaine; 4-[C₁₄-C₁₆ acylmethylamidodiethylammonio]-1-carboxybutane; C₁₆-C₁₈ acylamidodimethylbetaine; C₁₂-C₁₆ acylamidopentanediethyl-betaine; C₁₂-C₁₆ acylmethyl-amidodimethylbetaine, and coco amidopropyl betaine. Preferred betaines are C₁₂-C₁₈ dimethylamoniohexanoate and the C₁₀-C₁₈ acylamidopropane (or ethane) dimethyl (or diethyl) betaines. Also included are sulfobetaines (sultaines) of formula R(R¹)₂N⁺R² SO₃—, wherein R is a C₆-C₁₈ Hydrocarbyl group, such as a C₁₂-C₁₃ alkyl group; each R¹ is typically C₁-C₃ alkyl, and R² is a C₁-C₆ hydrocarbyl group. Examples of suitable sultaines are C₁₂-C₁₄ dihydroxyethylammonio propane sulfonate, and C₁₆-C₁₈ dimethylammonio hexane sulfonate.

In one embodiment, the dishwashing detergent formulations are aqueous detergent formulations including water as the main solvent. The water content of the aqueous detergent formulations can be from 40% to 95% by weight, from 45% to 90% by weight, or from 55% to 85% by weight based on the total weight of the detergent formulation.

In some embodiments, the detergent formulations include other optional components either to provide additional properties or make the product more commercially attractive. Exemplary optional components include organic solvents, enzymes, additives for improving the flow and drying behavior, additives for adjusting the viscosity and/or for stabilization, UV stabilizers, perfume, dyes, corrosion inhibitors, preservatives, bitter substances, organic salts, disinfectants, structuring polymers, defoamers, encapsulated ingredients, pH adjusters, and skin-feel-improving or nourishing additives. One or more of the optional components may be present in an amount from 0.1% to 5% by weight based on the total weight of the detergent formulation. The total amount of these optional components may be from 0.1% to 25% by weight.

### EXAMPLES

Detergent formulations comprising a linear alkylbenzene sulfonic acid (LASA), sodium hydroxide, and water were prepared. These formulations includes linear alkylbenzene sulfonates (LAS) having different average alkyl chain lengths. In this example, the formulations were made with linear alkylbenzene sulfonates (LAS) having average alkyl chain lengths of 11.6 (i.e., containing 50% C₁₂), 11.8 (i.e., containing 75% C₁₂), and 12 (i.e., containing 100% C₁₂). Sodium hydroxide was used as the neutralizing agent. These detergent formulations were tested for viscosity. These detergent formulations and their test results are summarized in Table 1.

TABLE 1
Standalone LAS formulations

| | 50% C12 | 75% C12 | 100% C12 |
|---|---|---|---|
| | LAS | LAS | LAS |
| Average alkyl chain length | 11.6 | 11.8 | 12 |
| | Formulation composition | | |
| Linear alkylbenzene sulfonic acid, | 15.13 | 15.22 | 14.54 |
| % | | | |
| NaOH* to achieve pH 8-9, % | 1.92 | 1.94 | 1.85 |

Water to 100%

| | | | |
|---|---|---|---|
| Formulation viscosity at 25 °C, cP | 47.68 | 192.03 | 184.30 |
| Formulation pH | 8.07 | 8.76 | 9.00 |

*NaOH can be a 50%, 0.01N or 0.1N solutions or combination of the three to achieve desirable pH.
Other neutralizing agents can also be used such as MIPA, DIPA and TIPA

The test results from Table 1 showed that viscosity increased significantly when the C₁₂ LAS content in the LAS increased from 50% to 75%. Also, the viscosity decreased slightly when the C₁₂ LAS content increased from 75% to 100%. It is noted that consumers perceive detergent formulations having a higher viscosity as having better cleaning performance.

Detergent formulations with linear alkylbenzene sulfonic acid (LASA), sodium hydroxide, and water were prepared with additional components. In the first formulation (F1), cocamidopropyl betaine (FB) was added to the detergent formulation. In the second formulation (F2), cocamidopropyl betaine (FB) and sodium lauryl ether sulfate 3EO (SLES 3) were added to the detergent formulation. Examples of both F1 and F2 were made with linear alkylbenzene sulfonates (LAS) of different average alkyl chain lengths, specifically, 11.6 (50% C₁₂), 11.8 (75% C₁₂) and 12 (100% C₁₂). These detergent formulations are summarized in Table 2.

TABLE 2
Two examples of LDL dishwashing formulations

| Ingredients | F1 | F2 |
|---|---|---|
| LAS | 15.6% | 11.8% |
| NaOH 50% | 3.6% | 1.4% |
| Sodium Lauryl Ether Sulfate 3EO (SLES 3) | | 7.2% |
| Cocamidopropyl betaine (FB) | 6.6% | 5.0% |
| Deionized water | 74.2% | 74.6% |

The detergent formulations of F1 and F2 and a retail detergent formulation were tested for viscosity and solids content. The retail detergent formulation includes C₁₂ LAS in an amount from 35%-50% by weight based on the total weight of the retail detergent formulation and also includes some ether sulfates and betaines. The pH of all formulations tested was in the range of 7-8. The test results are summarized in Table 3.

TABLE 3
Formulation viscosity and % Solids of tested formulation.

| Formulation viscosity | |
|---|---|
| at 25 °C, cP | % Solids |

| C12 Content | F1 type | F2 type | F1 type | F2 type |
|---|---|---|---|---|
| of LAS | formula | formula | formula | formula |
| 50% C12 | 424.84 | 416.83 | 19.28 | 20.08 |
| 75% C12 | 613.31 | 588 | 18.25 | 16.32 |
| 100% C12 | 4393.1 | 3014.4 | 19.9 | 18.05 |

| | | |
|---|---|---|
| Retail formula | 875.3 | 24.27 |

The tests showed that viscosity for both F1 and F2 formulations increased significantly when the C₁₂ LAS content was increased from 50% to 75%, such that the increased viscosities are closer to the viscosity of the retail formula. The test results indicate the viscosity for the 100% C₁₂ LAS content may be too high for consumer use. The tests also showed the percentage of solids in both F1 and F2 formulations decreased when the C₁₂ LAS content increased from 50% to 75%, but increased when the C₁₂ LAS content increased from 75% to 100%. Thus, the relationship between C₁₂ LAS content and solids content is not linear. Additionally, the percentage of solids in both formulations are significantly lower than the percentage of solids in the retail formula.

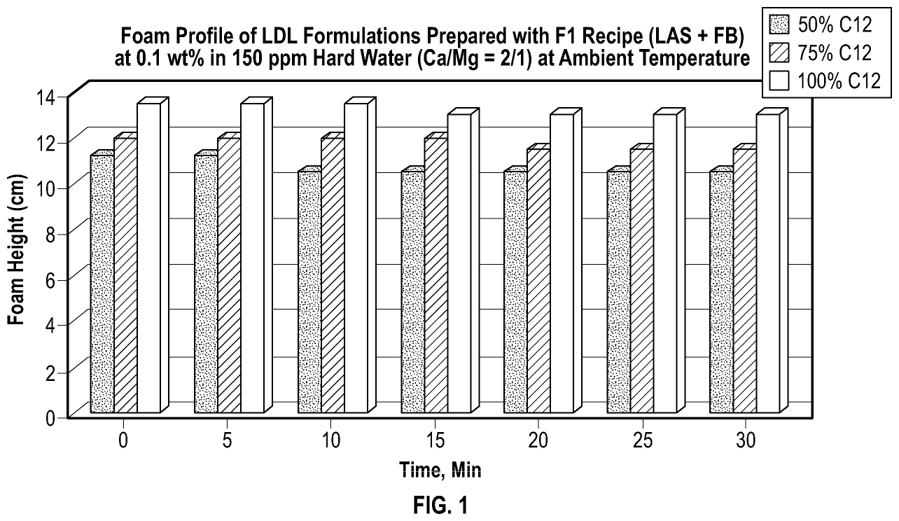

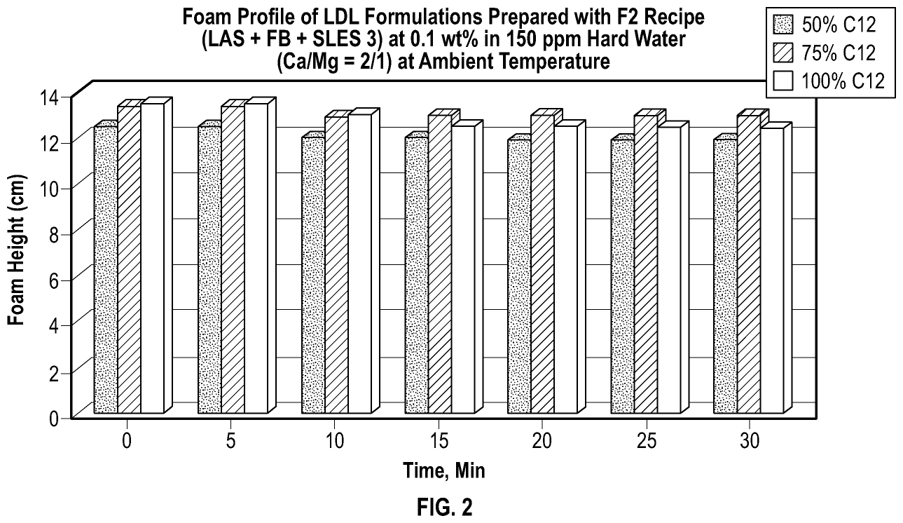

FIGS. 1-2 below show the foam performance of F1 and F2 formulations prepared according to Table 2. Foam performance of the formulations in the following examples was measured using Ross Miles method (ASTM D1173-53).

FIG. 1 is the foam profile of the LDL detergent formulations prepared in accordance with the F1 formulation (e.g., LAS+FB) at 0.1 wt % in 150 ppm hard water (Ca/Mg=2/1) at ambient temperature. It was observed that the initial foam height of the 75% C₁₂ LAS was higher than the 50% C₁₂ LAS. It was also observed that the foam height of the 75% C₁₂ LAS decreased at a slower rate than the 50% C₁₂ LAS. For example, the difference in foam height between the 75% C₁₂ LAS and the 50% C₁₂ LAS increased after 15 minutes.

FIG. 2 is the foam profile of LDL detergent formulations prepared in accordance with the F2 formulation (e.g., LAS+FB+SLES 3) at 0.1 wt % in 150 ppm hard water (Ca/Mg=2/1) at ambient temperature.

As seen in FIG. 2, the initial foam height of the 75% C₁₂ LAS formulation is greater than the 50% C₁₂ LAS formulation and about the same as the 100% C₁₂ LAS formulation. As time passed, the foam heights of the 75% C₁₂ LAS formulation and the 50% C₁₂ LAS formulation experienced minimal decrease. Also, the foam height of the 100% C₁₂ LAS formulation decreased faster than the 75% C₁₂ LAS formulation.

The F1, F2, and standalone LAS (i.e., formulation in Table 1 without FB and SLES) detergent formulations were prepared and tested for cleaning performance. In particular, the test involved using these formulations to clean soiled plates. The procedure of preparing the soil and soiled plates and cleaning the soiled plates is in accordance with CSPA Cleaning Products Division Test Methods Compendium-Fourth Edition, “Form Stability of Hand Dishwashing Detergents” CSPA Designation DCC-10, December 1979 (Re-approved in 2003), Page I-8 to I-11, with the following modifications: (1) Soil A was prepared and used as described; (2) Hard water concentration used for wash solutions was 150 ppm with Ca/Mg ratio of 2/1; (3) Wash solutions were prepared at 106 ppm of the detergent formulations (e.g., F1, F2, and the standalone LAS) in the hard water; (4) Soiled plates were cleaned at room temperature (21 °C); (5) Soiled plates were not stacked; (6) In the cleaning procedure, only the front of the plates was washed; (7) Plates are porcelain, narrow rim, and 9 inches in diameter.

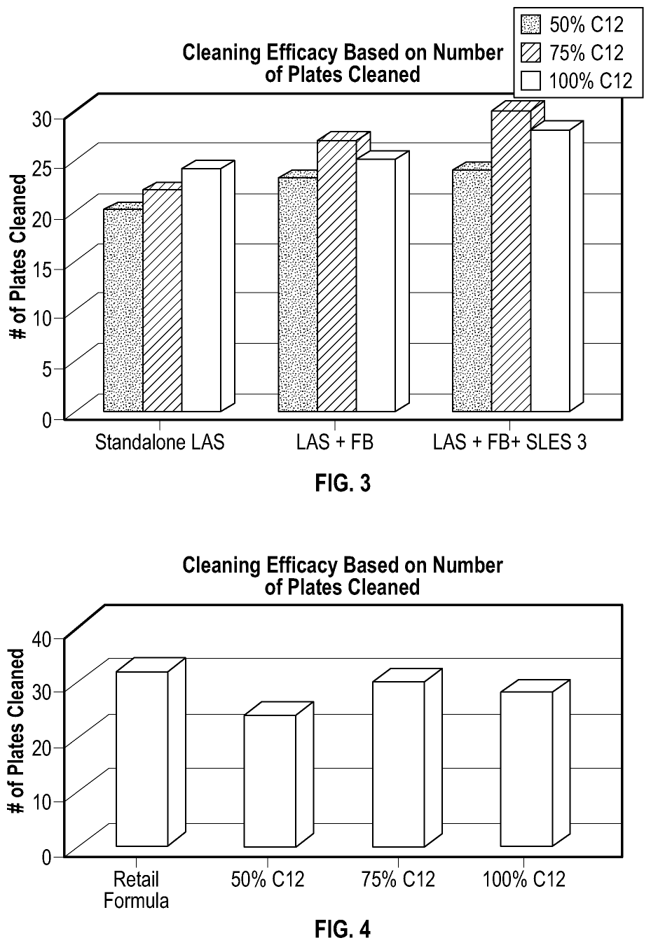

FIG. 3 is a summary of the cleaning performance of the different formulations, specifically, the standalone LAS formulation (i.e., without FB and SLE, listed in FIG. 3 as “Standalone LAS”), the F1 detergent formulation (listed in FIG. 3 as “LAS+FB”), and the F2 detergent formulation (listed in FIG. 3 as “LAS+FB+SLES 3”). It was observed that the cleaning efficacy of the Standalone LAS formulation increased with increasing C₁₂ content. The increase in plates cleaned from 50% C₁₂ LAS to 75% was more than the increase from 75% C₁₂ LAS to 100% C₁₂ LAS. For both F1 and F2 formulations, the 75% C₁₂ LAS achieved the best cleaning performance. That is, the 75% C₁₂ LAS performed better than both the 50% C₁₂ LAS and the 100% C₁₂ LAS. The additional components of F1 and F2 formulations boosted the cleaning performance of the 75% C₁₂ LAS more than the 50% C₁₂ LAS and the 100% C₁₂ LAS.

FIG. 4 compares the cleaning performance of different F₂ detergent formulations to the retail formulation discussed above. The F2 detergent formulations are listed as 50% C₁₂, 75% C₁₂, and 100% C₁₂ in FIG. 4. It was observed that the F2 detergent formulation with 75% C₁₂ LAS performed almost equally to the retail formula while having a lower percent of solids.

In some embodiments, a light duty liquid detergent formulation includes from 0.5% to 30% by weight of alkylbenzene sulfonates based on a total weight of the detergent formulation and at least 65% of the alkylbenzene sulfonates having a C₁₂ alkyl group. The detergent formulation also includes a neutralizing agent and water.

In some embodiments, a liquid dishwashing detergent includes a linear alkylbenzene sulfonate having an average alkyl chain length of from 11.7 carbons to 11.95 carbons. The linear alkylbenzene sulfonate present in an amount from 0.5% to 30% by weight based on a total weight of the dishwashing detergent. The dishwashing detergent also includes a neutralizing agent and water.

In one or more of the embodiments described herein, from 70% to 85% of the alkylbenzene sulfonates have a C₁₂ alkyl group.

In one or more of the embodiments described herein, from 72% to 78% of the alkylbenzene sulfonates have a C₁₂ alkyl group.

In one or more of the embodiments described herein, the neutralizing agent is selected from the group consisting of sodium hydroxide, potassium hydroxide, monoisopropanolamine (MIPA), diisopropranolamine (DIPA), and triisopropanolamine (TIPA).

In one or more of the embodiments described herein, the neutralizing agent is sodium hydroxide.

In one or more of the embodiments described herein, the alkylbenzene sulfonates are linear alkylbenzene sulfonates.

In one or more of the embodiments described herein, the detergent formulation further comprises a foam stabilizer in an amount from 4% to 10% by weight based on the total weight of the detergent formulation.

In one or more of the embodiments described herein, the foam stabilizer is a betaine having the formula:

R(R¹)₂N⁺R²COO⁻
wherein R is a C₆-C₁₈ hydrocarbyl group; each R¹ is typically C₁-C₃ alkyl group; and R² is a C₁-C₅ hydrocarbyl group.

In one or more of the embodiments described herein, the betaine is selected from the group consisting of: coconut acylamidopropyldimethyl betaine; hexadecyl dimethyl betaine; C₁₂-C₁₄ acylamidopropylbetaine; C₁₂-C₁₈ acylamidohexyldiethyl betaine; 4-[C₁₄-C₁₆ acylmethylamidodiethylammonio]-1-carboxybutane; C₁₆-C₁₈ acylamidodimethylbetaine; C₁₂-C₁₆ acylamidopentanediethyl-betaine; C₁₂-C₁₆ acylmethyl-amidodimethylbetaine, and cocamidopropyl betaine.

In one or more of the embodiments described herein, the foam stabilizer is an amine oxide.

In one or more of the embodiments described herein, the detergent formulation further comprises an anionic surfactant that is different from the alkylbenzene sulfonates, and the anionic surfactant is present in an amount from 2.0% to 12% by weight based on the total weight of the detergent formulation.

In one or more of the embodiments described herein, the anionic surfactant is an ether sulfate.

In one or more of the embodiments described herein, the anionic surfactant is sodium lauryl ether sulfate.

In one or more of the embodiments described herein, the linear alkylbenzene sulfonate having an average alkyl chain length of from 11.75 carbons to 11.85 carbons.

Although the present disclosure and its advantages have been described in detail, it should be understood that various changes, substitutions and alterations may be made herein without departing from the spirit and scope of the invention as defined by the appended claims.

What is claimed is:

1. A light duty liquid detergent formulation, comprising:
from 0.5% to 30% by weight of alkylbenzene sulfonates based on a total weight of the detergent formulation, at least 65% of the alkylbenzene sulfonates having a C₁₂ alkyl group;
a neutralizing agent; and
water.

2. The detergent formulation of claim 1, wherein from 70% to 85% of the alkylbenzene sulfonates have a C₁₂ alkyl group.

3. The detergent formulation of claim 1, wherein from 72% to 78% of the alkylbenzene sulfonates have a C₁₂ alkyl group.

4. The detergent formulation of claim 1, wherein the neutralizing agent is selected from the group consisting of sodium hydroxide, potassium hydroxide, monoisopropanolamine (MIPA), diisopropranolamine (DIPA), and triisopropanolamine (TIPA).

5. The detergent formulation of claim 1, wherein the neutralizing agent is sodium hydroxide.

6. The detergent formulation of claim 1, wherein the alkylbenzene sulfonates are linear alkylbenzene sulfonates.

7. The detergent formulation of claim 1, further comprising a foam stabilizer in an amount from 4% to 10% by weight based on the total weight of the detergent formulation.

8. The detergent formulation of claim 7, wherein the foam stabilizer is a betaine having the formula:
R(R¹)₂N⁺R²COO⁻
wherein R is a C₆-C₁₈ hydrocarbyl group; each R¹ is typically C₁-C₃ alkyl group; and R² is a C₁-C₅ hydrocarbyl group.

9. The detergent formulation of claim 8, wherein the betaine is selected from the group consisting of: coconut acylamidopropyldimethyl betaine; hexadecyl dimethyl betaine; C₁₂-C₁₄ acylamidopropylbetaine; C₁₂-C₁₈ acylamidohexyldiethyl betaine; 4-[C₁₄-C₁₆ acylmethylamidodiethylammonio]-1-carboxybutane; C₁₆-C₁₈ acylamidodimethylbetaine; C₁₂-C₁₆ acylamidopentanediethyl-betaine; C₁₂-C₁₆ acylmethyl-amidodimethylbetaine, and cocamidopropyl betaine.

10. The detergent formulation of claim 7, wherein the foam stabilizer is an amine oxide.

11. The detergent formulation of claim 1, further comprising an anionic surfactant different from the alkylbenzene sulfonates, the anionic surfactant present in an amount from 2.0% to 12% by weight based on the total weight of the detergent formulation.

12. The detergent formulation of claim 11, wherein the anionic surfactant is an ether sulfate.

13. The detergent formulation of claim 11, wherein the anionic surfactant is sodium lauryl ether sulfate.

14. A liquid dishwashing detergent, comprising:
a linear alkylbenzene sulfonate having an average alkyl chain length of from 11.7 carbons to 11.95 carbons, the linear alkylbenzene sulfonate present in an amount from 0.5% to 30% by weight based on a total weight of the dishwashing detergent;
a neutralizing agent; and
water.

15. The liquid dishwashing detergent of claim 14, wherein the linear alkylbenzene sulfonate having an average alkyl chain length of from 11.75 carbons to 11.85 carbons.

16. The liquid dishwashing detergent of claim 14, wherein the neutralizing agent is selected from the group consisting of sodium hydroxide, potassium hydroxide, monoisopropanolamine (MIPA), diisopropranolamine (DIPA), and triisopropanolamine (TIPA).

17. The liquid dishwashing detergent of claim 14, further comprising a foam stabilizer in an amount from 4% to 10% by weight based on the total weight of the liquid dishwashing detergent.

18. The liquid dishwashing detergent of claim 17, wherein the foam stabilizer is a betaine selected from the group consisting of coconut acylamidopropyldimethyl betaine; hexadecyl dimethyl betaine; C₁₂-C₁₄ acylamidopropylbetaine; C₁₂-C₁₈ acylamidohexyldiethyl betaine; 4-[C₁₄-C₁₆ acylmethylamidodiethylammonio]-1-carboxybutane; C₁₆-C₁₈ acylamidodimethylbetaine; C₁₂-C₁₆ acylamidopentanediethyl-betaine; C₁₂-C₁₆ acylmethyl-amidodimethylbetaine, or cocamidopropyl betaine.

19. The liquid dishwashing detergent of claim 17, wherein the foam stabilizer is an amine oxide.

20. The liquid dishwashing detergent of claim 14, further comprising an ether sulfate present in an amount from 2.0% to 12% by weight based on the total weight of the liquid dishwashing detergent.
